(19) United States
(12) Patent Application Publication
(10) Pub. No.: US 2025/0265995 A1
(43) Pub. Date: Aug. 21, 2025

(54) LIGHT-EMITTING DEVICE, IMAGE FORMING DEVICE, IMAGE CAPTURING DEVICE, DISPLAY DEVICE, ELECTRONIC APPARATUS, ILLUMINATION DEVICE, MOVING BODY, AND WEARABLE DEVICE

(71) Applicant: CANON KABUSHIKI KAISHA, Tokyo (JP)

(72) Inventor: TOSHIYUKI OGAWA, Chiba (JP)

(21) Appl. No.: 19/042,394

(22) Filed: Jan. 31, 2025

(30) Foreign Application Priority Data
Feb. 15, 2024 (JP) 2024-021448

(51) Int. Cl. G09G 3/3233; G09G 3/32

(52) U.S. Cl. CPC G09G 3/3233; G09G 3/32; G09G 2320/0233; G09G 2320/0242

(57) ABSTRACT

A light emitting device in which a plurality of pixels are arranged in a matrix in a semiconductor substrate. Each of the plurality of pixels includes a light-emitting element, a driving transistor configured to supply a current to the light-emitting element, and a switching transistor configured to control the light-emitting element. A gate electrode of the switching transistor is provided on at least two faces of four faces surrounding a cross section of a region to be a channel.

### BACKGROUND OF THE INVENTION

### Field of the Invention

One disclosed aspect of the embodiments relates to a light-emitting device, for example, a light-emitting device including an organic light-emitting element, and an image forming device, an image capturing device, a display device, an electronic apparatus, an illumination device, a moving body, and a wearable device to each of which the light-emitting device is applied.

### Description of the Related Art

As a light-emitting element, for example, an organic light-emitting element is used. Japanese Patent Laid-Open No. 2022-85287 discloses that a switching transistor configured to control light emission and non-light emission of a light-emitting element is provided between the anode and cathode as two terminals of the light-emitting element.

If the source-drain voltage or the well voltage fluctuates, the switching transistor can be incompletely turned on/off, causing incomplete control of light emission and non-light emission of the light-emitting element. As a result, the light emission amount may vary, and the light emission quality may deteriorate.

### SUMMARY OF THE INVENTION

One disclosed embodiment has been made in consideration of the above-described problem, and provides a light-emitting device having an arrangement advantageous in suppressing deterioration of light emission quality.

According to one aspect of the disclosure, there is provided a light-emitting device in which a plurality of pixels are arranged in a matrix in a semiconductor substrate. Each of the plurality of pixels includes a light-emitting element, a driving transistor configured to supply a current to the light-emitting element, and a switching transistor configured to control the light-emitting element. A gate electrode of the switching transistor is provided on at least two faces of four faces surrounding a cross section of a region to be a channel.

Further features of the disclosure will become apparent from the following description of exemplary embodiments with reference to the attached drawings.

### BRIEF DESCRIPTION OF THE DRAWINGS

FIG. 1 is a block diagram of a light-emitting device;

FIG. 2 is a schematic view showing the arrangement of a pixel;

FIG. 3 is a plan view of pixels according to the first embodiment;

FIGS. 4A and 4B are cross-sectional views of the pixel according to the first embodiment;

FIGS. 5A to 5D are views for explaining formation of a pixel circuit according to the first embodiment;

FIGS. 6A to 6D are views for explaining formation of the pixel circuit according to the first embodiment;

FIGS. 7A to 7D are views for explaining formation of the pixel circuit according to the first embodiment;

FIG. 8 is a plan view of pixels according to the second embodiment;

FIGS. 9A and 9B are cross-sectional views of the pixel according to the second embodiment;

FIGS. 10A to 10D are views for explaining formation of a pixel circuit according to the second embodiment;

FIGS. 11A to 11D are views for explaining formation of the pixel circuit according to the second embodiment;

FIGS. 12A to 12D are views for explaining formation of the pixel circuit according to the second embodiment;

FIGS. 13A to 13C are schematic views showing an example of an image forming device;

FIG. 14 is a schematic view showing an example of a display device;

FIG. 15A is a schematic view showing an example of an image capturing device;

FIG. 15B is a schematic view showing an example of an electronic apparatus;

FIG. 16A is a schematic view showing an example of a display device;

FIG. 16B is a schematic view showing an example of a display device;

FIG. 17A is a schematic view showing an example of an illumination device;

FIG. 17B is a schematic view showing an example of an automobile including a vehicle lighting appliance; and

FIGS. 18A and 18B are schematic views each showing an example of a wearable device.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

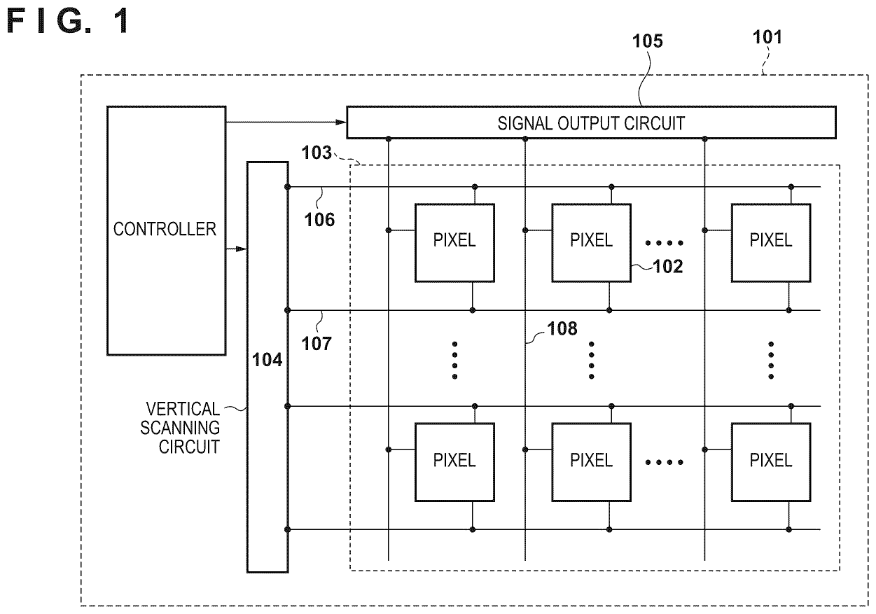

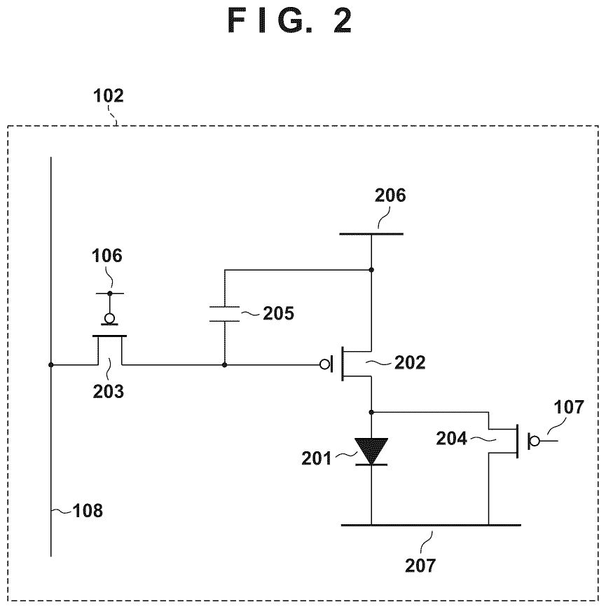

FIG. 1 is a block diagram of a light-emitting device 101 according to this embodiment. This embodiment will be described here by taking an active matrix display device as an example. As shown in FIG. 1, the light-emitting device 101 includes a pixel array portion 103, and a driver arranged around the pixel array portion 103. The pixel array portion 103 includes a plurality of pixels 102 two-dimensionally arranged in a matrix, and each pixel 102 includes a circuit including a light-emitting element 201 and transistors arranged around the light-emitting element shown in FIG. 2.

The light-emitting device 101 includes a driver configured to drive each pixel. The driver includes a vertical scanning circuit 104 and a signal output circuit 105. The driver can be controlled by a controller to operate the light-emitting device as a display device. In FIG. 1, in the pixel array portion 103 where the pixels 102 are arranged in a matrix, a first scanning line 106 and a second scanning line 107 are arranged for each pixel row along a row direction. Further, a signal line 108 is arranged for each pixel column along a column direction.

Each of the first scanning line 106 and the second scanning line 107 is connected to the output terminal in the corresponding row in the vertical scanning circuit 104. Each signal line 108 is connected to the output terminal in the corresponding column in the signal output circuit 105.

The vertical scanning circuit 104 can be formed from a shift resistor, which sequentially shifts a start pulse in synchronization with a clock pulse, or the like. When writing a video signal in each pixel 102 in the pixel array portion 103, the vertical scanning circuit 104 supplies a write control signal to the first scanning line 106. In a non-light emission period, the vertical scanning circuit 104 supplies a reset signal to the second scanning line 107.

The signal output circuit 105 outputs a signal voltage (luminance signal) corresponding to luminance information supplied from the outside. The signal voltage output from the signal output circuit 105 is supplied to the corresponding pixel 102 via the signal line 108.

In the pixel where the write signal from the first scanning line 106 is set at active level, the light-emitting element 201 can emit light in accordance with the signal voltage supplied from the signal line 108. In the pixel to which the reset signal is supplied from the second scanning line, the light-emitting element can be controlled to be set in a non-light emission state. The vertical scanning circuit 104 can sequentially output the write control signal and the reset signal for each row.

Note that the driver need not be arranged in the same substrate as the pixel array portion 103. The pixel array portion 103 may be arranged in the first substrate, and at least a part of the driver may be arranged in the second substrate, thereby stacking the first substrate and the second substrate.

In this specification, when the light-emitting device 101 is a monochrome display compatible display device, one pixel as a unit for forming a monochrome image corresponds to the pixel 102. On the other hand, when the light-emitting device 101 is a color display compatible display device, one pixel as a unit for forming a color image may be formed from a plurality of sub-pixels, and the plurality of sub-pixels may correspond to the pixel 102. More specifically, in the color display compatible display device, one pixel may be formed from three sub-pixels including a sub-pixel that emits red (R) light, a sub-pixel that emits green (G) light, and a sub-pixel that emits blue (B) light.

One pixel is not limited to a combination of the sub-pixels of the three primary colors of RGB. That is, it is also possible to form one pixel by adding one or a plurality of color sub-pixels to the sub-pixels of the three primary colors. More specifically, it is also possible to form one pixel by adding a sub-pixel that emits white (W) light to improve luminance, or form one pixel by adding at least one sub-pixel that emits complementary color light to extend the color reproduction range.

FIG. 2 is a circuit diagram showing an example of the arrangement of the pixel 102 of the light-emitting device 101 shown in FIG. 1. For the light-emitting element 201, a current-driven electro-optical element whose light emission luminance changes in accordance with the value of a current flowing through the element, for example, an organic light emitting diode (OLED) element can be used. A case in which the electro-optical element is an OLED element will be described below. The light-emitting element 201 includes an organic layer including a light emitting layer between an anode electrode and a cathode electrode. The organic layer may include at least one of a hole injection layer, a hole transport layer, an electron injection layer, and an electron transport layer, in addition to the light emitting layer.

The pixel 102 may include an OLED element functioning as the light-emitting element 201, and a driving circuit for driving the light-emitting element 201. The pixel 102 includes the light-emitting element 201, a driving transistor 202, and a write transistor 203. One of the drain and source of the driving transistor 202 is connected to a power supply potential Vdd, and the other is connected to one main terminal of the light-emitting element 201.

In this example, the driving transistor 202 is connected to the anode electrode of the light-emitting element 201. The pixel 102 further includes a switching transistor 204 and a first capacitive element 205.

In this embodiment, one of the drain and source of the switching transistor 204 is connected to a connection portion between the driving transistor 202 and the light-emitting element 201. In this example, the other of the drain and source of the switching transistor 204 is connected to a power supply potential Vss serving as a reference. In this embodiment, the power supply potential Vdd is higher than the power supply potential Vss.

Here, the total number of transistors and the capacitive element and the combination of the conductivity types of the transistors are merely examples, and not limited to this arrangement. The total number of the transistors and the capacitive element may be the same for the plurality of pixels, or pixels different in the total number of the transistors and the capacitive element may be included in the light-emitting device.

When the light-emitting device is used as a color display compatible display device, the arrangement may be changed in accordance with each color. The capacitance value of the first capacitive element 205 in the sub-pixel that emits blue light may be larger than the capacitance value of the first capacitive element 205 in the sub-pixel that emits green light. In the following description, when a transistor is connected between an element A and an element B, one terminal (one of the source region and drain region) of the transistor is connected to the element A, and the other terminal (the other of the source region and drain region) of the transistor is connected to the element B.

A circuit operation of the pixel 102 will be described. In this embodiment, one end of a current path including the light-emitting element 201, the driving transistor 202, and the switching transistor 204 is connected to the power supply potential Vss, and the other end is connected to the power supply potential Vdd.

More specifically, one (the cathode in the example shown in FIG. 2) of the main terminals of the light-emitting element 201 and one (the drain region in the example shown in FIG. 2) of the drain and source of the switching transistor 204 are connected to the power supply potential Vss. The other (anode) of the main terminals of the light-emitting element 201 and the other (the source region in the example shown in FIG. 2) of the drain and source of the switching transistor 204 are connected to the power supply potential Vdd via the driving transistor 202.

One (the drain region in the example shown in FIG. 2) of the drain and source of the write transistor 203 is connected to the gate of the driving transistor 202, and the other (the source region in the example shown in FIG. 2) of the drain and source of the write transistor 203 is connected to the signal line 108. The gate of the write transistor 203 is connected to the first scanning line 106.

One (the drain region in the example shown in FIG. 2) of the drain and source of the switching transistor 204 is connected to the power supply potential Vss 207. The gate of the switching transistor 204 is connected to the second scanning line 107. The cathode electrode of the light-emitting element 201 is also connected to the power supply potential Vss. Therefore, when the switching transistor 204 is controlled to become conductive, the two main terminals (anode and cathode) of the light-emitting element 201 are short-circuited. To control the light-emitting element 201 to set it in a non-light emission state, the switching transistor 204 is turned on in a non-light emission period. With this, the anode of the light-emitting element 201 can be connected to the power supply potential Vss 207, thereby setting the light-emitting element 201 in the non-light emission state. The one terminal of the drain and source of the switching transistor 204 may be connected a predetermined potential that can set the light-emitting element 201 in the non-light emission state when the switching transistor is controlled to be conductive (if the Vdd is a positive potential, the predetermined potential is preferably a more negative potential than the Vss).

The first capacitive element 205 is connected between a node connected to the gate of the driving transistor 202 and a node connected to one (the source in the example shown in FIG. 2) of the drain and source of the driving transistor 202. The first capacitive element 205 can be selected from a parasitic capacitance, a Metal-Insulator-Metal (MIM) structure, a Metal-Oxide-Semiconductor (MOS) structure, and the like.

The driving transistor 202 supplies a current from the power supply potential Vdd 206 to the light-emitting element 201, thereby causing it to emit light. More specifically, the driving transistor 202 supplies, to the light-emitting element 201, a current corresponding to the signal voltage of the signal line 108. This causes the light-emitting element 201 to emit light by current driving.

The write control signal is supplied to the gate of the write transistor 203 from the vertical scanning circuit 104 via the first scanning line 106. The write transistor 203 controls a conductive state and a non-conductive state in accordance with the write control signal. The write transistor 203 can transmit the luminance signal to the light-emitting element 201. When the write transistor 203 is set in the conductive state, the write transistor 203 samples the signal voltage of the luminance signal corresponding to the luminance information supplied from the signal output circuit 105 via the signal line 108, and writes it in the pixel 102. The written signal voltage is applied to the gate of the driving transistor 202.

In this embodiment, the description will be continued for the example in which the OLED element is used as the light-emitting element 201. When the light-emitting element 201 emits light, the amount of current flowing through the driving transistor 202 changes in accordance with the signal voltage applied to the gate of the driving transistor 202 from the signal line 108 via the write transistor 203. This charges the electric capacitance between the anode and cathode of the light-emitting element 201 up to a predetermined potential, and a current corresponding to the potential difference flows. Thus, the light-emitting element 201 emits light with a predetermined luminance.

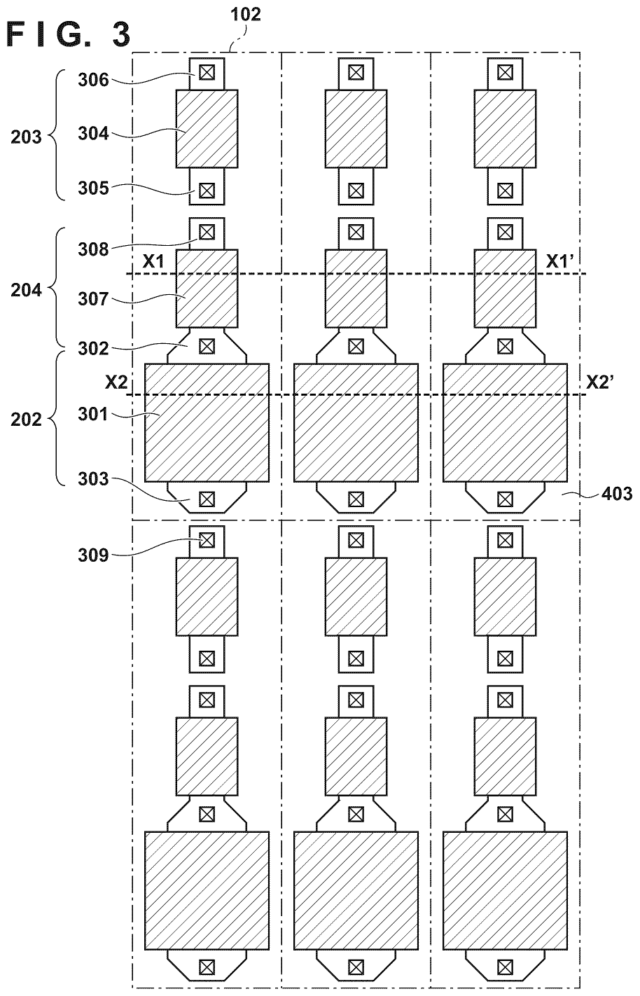

FIG. 3 is a schematic plan view showing a part of the pixel array portion 103 where the plurality of pixels 102 are arranged. A description will be given here using a p-channel MOSFET as an example of the transistor, but an n-channel MOSFET may be used. An arrangement in which a p-channel MOSFET and an n-channel MOSFET are mixed may be used.

The driving transistor 202 is formed from a gate electrode 301, a p-type diffusion region 302 functioning as one of a source region and a drain region, and a p-type diffusion region 303 functioning as the other of the source region and the drain region. In FIG. 3, the gate electrode 301 is connected to one terminal of the first capacitive element 205 shown in FIG. 2, and the diffusion region 303 is connected to the other terminal of the first capacitive element 205. Furthermore, the diffusion region 303 is connected to the power supply potential Vdd 206. The diffusion region 302 is connected to the anode of the light-emitting element 201.

The write transistor 203 is formed from a gate electrode 304, a p-type diffusion region 305 functioning as one of a source region and a drain region, and a p-type diffusion region 306 functioning the other of the source region and the drain region. In the example shown in FIG. 3, the diffusion region 305 can function as the drain region, and the diffusion region 306 can function as the source region. The diffusion region 305 is connected to the gate electrode 301 of the driving transistor 202, and holds the signal voltage. When the write transistor 203 is in the OFF state, the potential of the diffusion region 305 functioning as the drain region of the write transistor 203 and the potential of the gate electrode of the driving transistor 202 are in a floating state.

The potential of the gate electrode 301 of the driving transistor 202 and the potential of the diffusion region 305 functioning as the drain region of the write transistor 203 are equipotential. The potential of the gate electrode 301 of the driving transistor 202 decides the drain current of the driving transistor 202, thereby deciding the luminance of the light-emitting element 201. The diffusion region 306 is connected to the signal line 108, and the gate electrode 304 is connected to the first scanning line 106.

The switching transistor 204 is formed from a gate electrode 307, the p-type diffusion region 302 functioning as one of a source region and a drain region, and a p-type diffusion region 308 functioning the other of the source region and the drain region. The gate electrode 307 is connected to the second scanning line 107. The diffusion region 302 is shared by the driving transistor 202 and the switching transistor 204. However, the present invention is not limited to this, and each of the driving transistor 202 and the switching transistor 204 may have an independent diffusion region. The diffusion region 308 is connected to the power supply potential Vss 207. In a planar view, the diffusion region closest to the diffusion region 308 is the diffusion region 305.

A contact plug 309 is connected to each of the source regions and the drain regions. Each of the source regions and the drain regions may have a Lightly Doped Drain (LDD) structure, and this can be expected to suppress a leakage current.

The region connected to the contact plug 309 may have a higher impurity concentration than in the source region and the drain region around it. In the source region and the drain region, the portion connected to the contact plug may have a higher impurity concentration than in a portion forming an interface with a well 402. If a silicide containing tungsten (W), cobalt (Co) or the like is formed in the region connected to the contact plug 309, the electric resistance can be reduced.

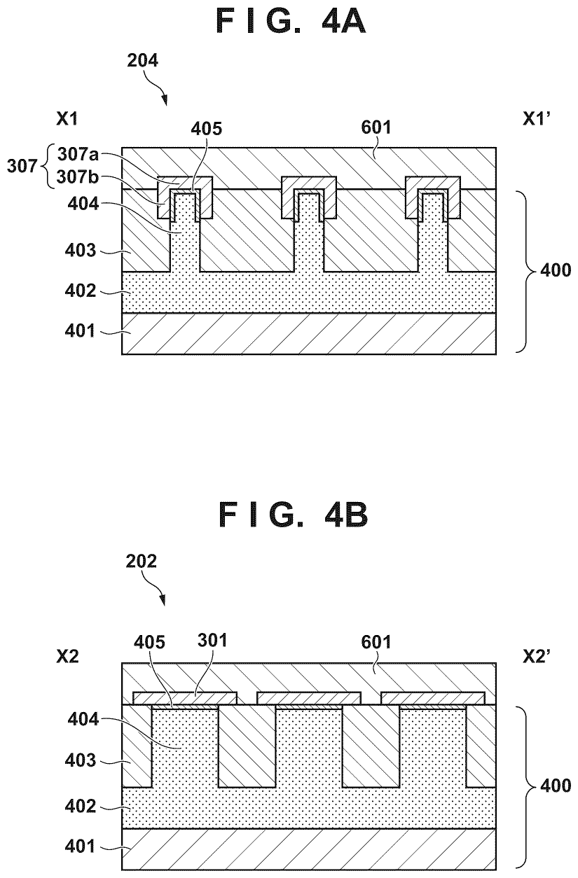

The structure of the switching transistor 204 and the structure of the driving transistor 202 will be described with reference to FIGS. 4A and 4B. FIG. 4A is a cross-sectional view taken along a line X1-X1′ shown in FIG. 3, which is a view for explaining the cross-sectional structure of the switching transistor 204. Explaining FIGS. 4A and 4B in relation to FIG. 3, each of the section taken along the line X1-X1′ and the section taken along a line X2-X2′ is a cross section perpendicular to a current flowing between the drain and the source.

A substrate 400 is a semiconductor substrate, and a single crystal silicon substrate will be described as an example in this embodiment. The n-type well 402 is formed on a p-type substrate 401. An element isolation portion 403 is formed in a part of the n-type well 402. The element isolation portion 403 is a shallow trench isolation (STI), a local oxidation of silicon (LOCOS), or the like, and made of an insulator such as silicon oxide. A channel region 404 is a part of the n-type well 402, and arranged between the element isolation portions 403.

The gate electrode 307 is arranged on the channel region 404. The gate electrode 307 is made of polysilicon in this example, but may be formed of another conductor material. An interlayer film 601 is arranged on the gate electrode 307. The interlayer film 601 is made of an insulator such as silicon oxide.

A gate insulating film 405 is arranged between the gate electrode 307 and the channel region 404. Silicon oxide can be used for the gate insulating film 405. To ensure the breakdown voltage, the film thickness is preferably selected in accordance with the voltage used in the circuit. To drive the light-emitting element 201, the switching transistor 204 needs to be used with a relatively high voltage. More specifically, the voltage is, for example, about 5 to 20 V. When used with such a voltage, the film thickness of the gate insulating film 405 of about 10 to 40 nm can ensure the breakdown voltage. For the same region, the gate length needs to have a length that can ensure the breakdown voltage. More specifically, the gate length is, for example, 0.5 μm or more.

The gate electrode 307 includes not only a portion on the substrate 400 but also a portion embedded in the substrate 400, thereby having a vertical gate electrode structure. The gate electrode 307 is formed from a portion 307a on the substrate 400 and a portion 307b embedded in a groove of the substrate 400, thereby surrounding the channel region 404 not only from above the substrate 400 but also from both sides. The gate electrode 307 can have an inverted U-shape or a U-shape with respect to the bottom surface of the substrate 400 when viewed in a cross section perpendicular to the current flow direction. With respect to the channel region surrounded by the gate electrode 307, the element isolation portion 403 can be located outside the gate electrode 307 so as to be adjacent to the gate electrode 307.

Such a trench gate structure including a gate electrode in a groove of a substrate allows the electric field of the gate electrode 307 to influence the channel region 404 from more faces than a gate electrode of a conventional planar structure. This can improve the controllability of the ON/OFF operation caused by forming a channel between the source and the drain due to the gate voltage. Here, improvement in controllability refers to an increase in current in the ON state and a reduction in leakage current in the OFF state.

In the circuit arrangement of the pixel 102, the switching transistor 204 has a role of controlling light emission and non-light emission of the light-emitting element 201. Therefore, it is required to be reliably turned on/off even in a situation where the source-drain voltage or the well voltage fluctuates. If the switching transistor 204 is incompletely turned on/off, this can cause incomplete control of light emission and non-light emission of the light-emitting element 201 and variation of the light emission amount of the light-emitting element 201, leading to deterioration of image quality. If the switching transistor 204 has the structure according to this embodiment, the controllability of the ON/OFF operation due to the gate voltage can be improved, and an improvement in image quality can be expected.

In this embodiment, the portion 307b of the gate electrode is shown as being embedded in a part of the element isolation portion 403. However, the gate electrode may be embedded in a part of the channel region 404, or may be embedded across a part of the element isolation portion 403 and a part of the channel region 404.

In this embodiment, when the channel region 404 through which a current flows between the source and the drain is viewed in a cross section cut perpendicularly to the current flow direction, the portions 307a and 307b of the gate electrode are arranged on three faces of four faces surrounding the cross section. More specifically, the gate electrode is arranged, along the current flow direction, on three faces in total including one face on the front surface side of the substrate and two faces on both sides of the region to be the channel. However, the gate electrode may be provided on two faces including a face on the front surface side of the substrate and a face on one side of the region surrounding the channel. Alternatively, the gate electrode in the groove may be embedded in the central portion of the channel region 404.

By making the depth of the portion 307b of the gate electrode shallower than the depth of the element isolation portion 403, it becomes easy to process the groove for embedding the portion 307b of the gate electrode when forming the transistor. The depth of the portion 307b of the gate electrode is preferably more than twice the film thickness of the gate insulating film 405. In this case, parts of the portion 307b of the gate electrode face each other on the side surfaces of the channel region 404, and it can be expected that the electric field from the portion 307b of the gate electrode influences the side surface of the channel region 404 more effectively. This can further improve the controllability of the ON/OFF operation (channel formation) due to the gate voltage.

FIG. 4B is a cross-sectional view of the driving transistor 202 taken along the line X2-X2′ in FIG. 3. The difference from FIG. 4A is that the gate electrode 301 has a planar structure in which the gate electrode 301 is arranged only on the substrate 400 and is not embedded in the substrate 400.

When the light-emitting element 201 emits light, the amount of current flowing through the driving transistor 202 changes in accordance with the signal voltage applied to the gate of the driving transistor 202 from the signal line 108 via the writing transistor 203. Therefore, if the characteristics of the driving transistor 202 vary among the pixels, deterioration of image quality such as a rough image can occur.

If a trench gate structure as shown in FIG. 4A is applied to the driving transistor 202, a groove for embedding the gate electrode 301 needs to be formed in the element isolation portion 403, and this can cause processing variation in the shape of the gate electrode 301. The processing variation can result in the characteristic variation of the driving transistor 202.

On the other hand, with a planar structure as shown in FIG. 4B, it is easy to suppress the characteristic variation caused by the variation in the shape of the gate electrode 301, and deterioration of image quality can be minimized. If the characteristic variation of the driving transistor 202 is allowed, a transistor having a trench gate structure as shown in FIG. 4A may be used. The write transistor 203 may have a trench gate structure or a planar structure, and can be appropriately selected depending on the circuit design, pixel circuit layout, and the like.

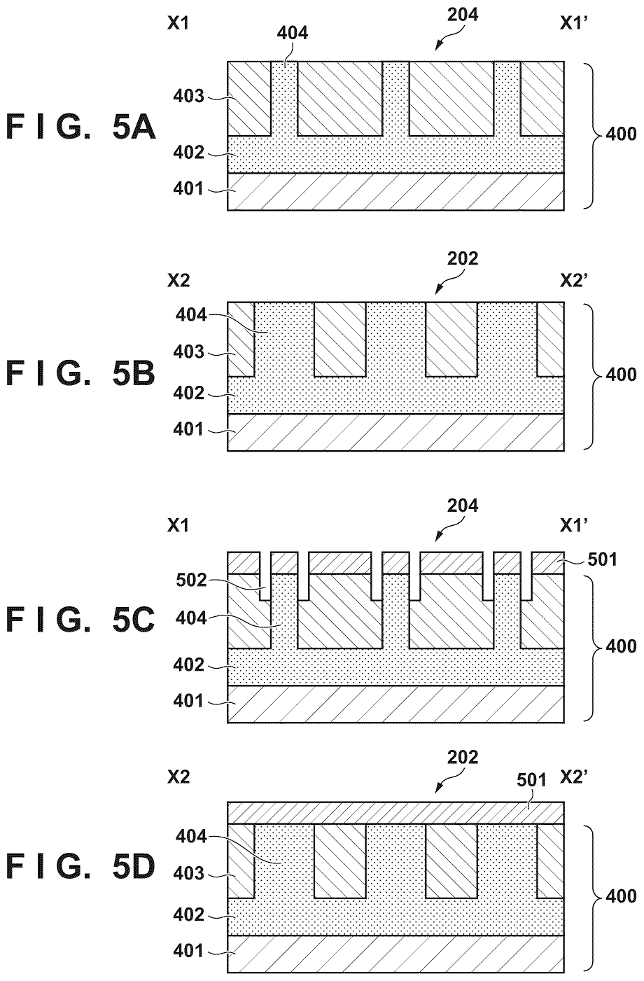

FIGS. 5A to 5D, 6A to 6D, and 7A to 7D are views for explaining the process of forming each transistor that constitutes the pixel circuit while comparing the cross-sectional structures of the switching transistor 204 and the driving transistor 202. The method of forming transistors according to this embodiment will be described below. Each of FIGS. 5A, 5C, 6A, 6C, 7A, and 7C is a cross-sectional view of the switching transistor 204 shown in FIG. 3 taken along the line X1-X1′. Each of FIGS. 5B, 5D, 6B, 6D, 7B, and 7D is a cross-sectional view of the driving transistor 202 taken along line the X2-X2′.

As shown in FIGS. 5A and 5B, the element isolation portion 403 is formed in the substrate 400 formed from the p-type substrate 401 and the n-type well 402. The element isolation portion 403 can be made of silicon oxide or the like. The element isolation portion 403 can have an STI structure, a LOCOS structure, or the like. A region of the n-type well 402 sandwiched between the element isolation portions 403 is to be the channel region 404.

Then, as shown in FIGS. 5C and 5D, a resist mask 501 for the switching transistor 204 is formed on the substrate 400, and the element isolation portion 403 is partially removed by dry etching or the like to form a groove 502. In this embodiment, the groove 502 is formed between the n-type well 402 to be the channel region 404 and the element isolation portion 403. The gate electrode 307 is to be formed in the groove 502. Here, since the driving transistor 202 has a planar structure, no groove is formed. In order to form the gate electrode of the switching transistor 204 having a trench gate structure, the groove 502 is formed only in the region of the switching transistor 204. The groove 502 may be formed using wet etching. The width of the groove 502 is about 100 to 400 nm.

After the groove 502 is formed, the resist mask 501 is removed. Thereafter, sacrificial oxidation may be performed to remove a layer damaged by etching of the groove 502. Isotropic etching may also be performed to round the bottom shape of the groove 502 to ensure the embedding characteristic of a polysilicon film. To adjust the threshold value of the transistor, channel doping may be performed by ion implantation or the like.

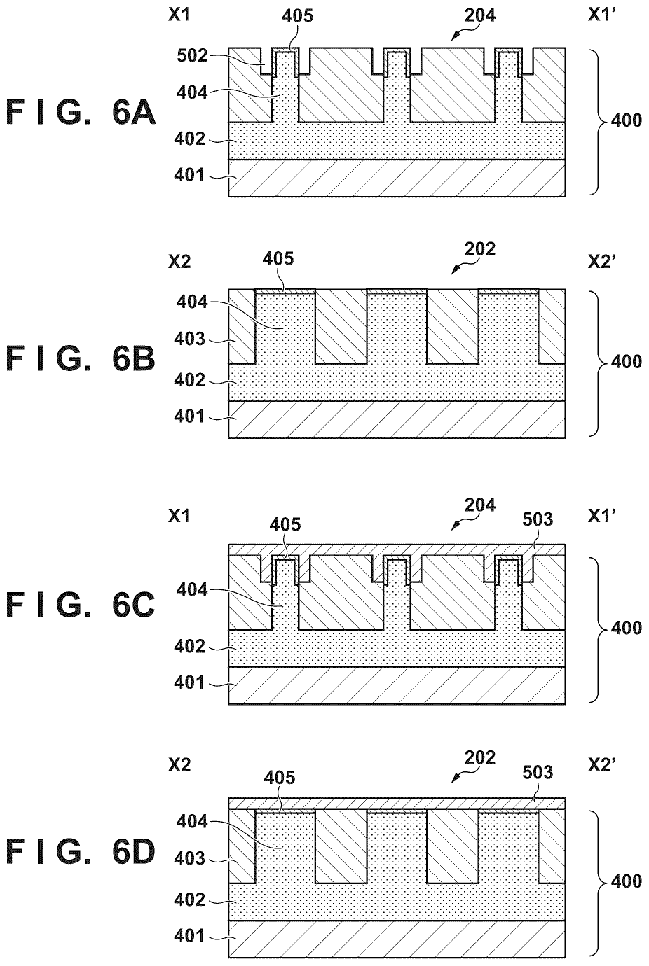

As shown in FIGS. 6A and 6B, the gate insulating film 405 is formed on the substrate 400. The gate insulating film 405 can be made of silicon oxide. The silicon oxide film can be formed by thermal oxidation, In situ steam generation (ISSG) oxidation, or the like. The gate insulating film 405 can be formed on a portion of the groove 502 including the sidewall of the region to be the channel and on the surface of the substrate 400 including the top face of the region to be the channel. The film thickness of the gate insulating film 405 is about 10 to 40 nm, and can be appropriately selected in accordance with the voltage to be applied to the transistor.

As shown in FIGS. 6C and 6D, an electrode made of a polysilicon film 503 is formed on the surface of the substrate 400. At this time, an electrode is also formed in the groove 502 of the switching transistor 204. The material of the electrodes is not limited to polysilicon. The film thickness of the polysilicon film 503 is about 100 to 400 nm. If the width of the above-described groove 502 is set to be equal to or less than twice the film thickness of the polysilicon film 503, the embedding characteristic of the polysilicon film 503 in the groove 502 is improved. Furthermore, if the width of the groove 502 is set to be equal to or less than the film thickness of the polysilicon film 503, it is possible to suppress a step of the polysilicon film 503 generated above the groove 502.

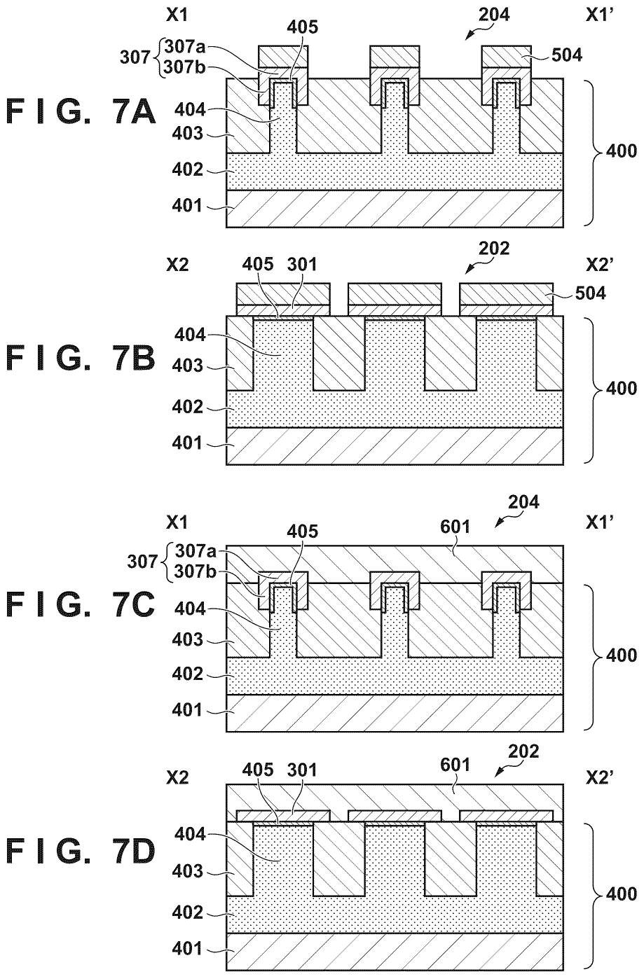

As shown in FIGS. 7A and 7B, a resist mask 504 is formed on the polysilicon film 503, and the gate electrodes 301 and 307 are formed by dry etching or the like.

As shown in FIGS. 7C and 7D, after the resist mask 504 is removed, the interlayer film 601 is formed. Before forming the interlayer film 601, it is possible to form the source region and the drain region by ion implantation or the like, and to form a silicide containing W, Co, or the like in the region to be connected to the contact plug 309, as appropriate.

In this manner, the gate electrode is formed that has an inverted U-shape or U-shape in the cross section of the switching transistor 204 taken along the line X1-X1′. The channel region 404 can be formed inside the gate electrode having the inverted U-shaped or U-shaped cross section. The driving transistor 202 includes the planar type gate electrode formed therein. According to the above-described formation method, it is possible to simultaneously form, on the same substrate, a transistor including a gate electrode having a trench gate structure and a transistor including a gate electrode having a planar structure.

### Second Embodiment

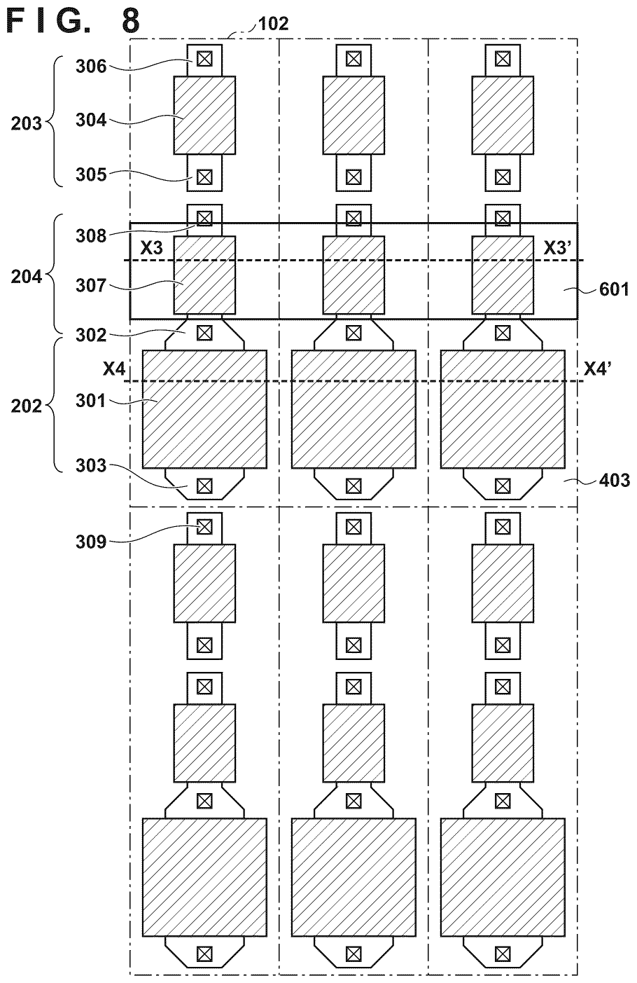

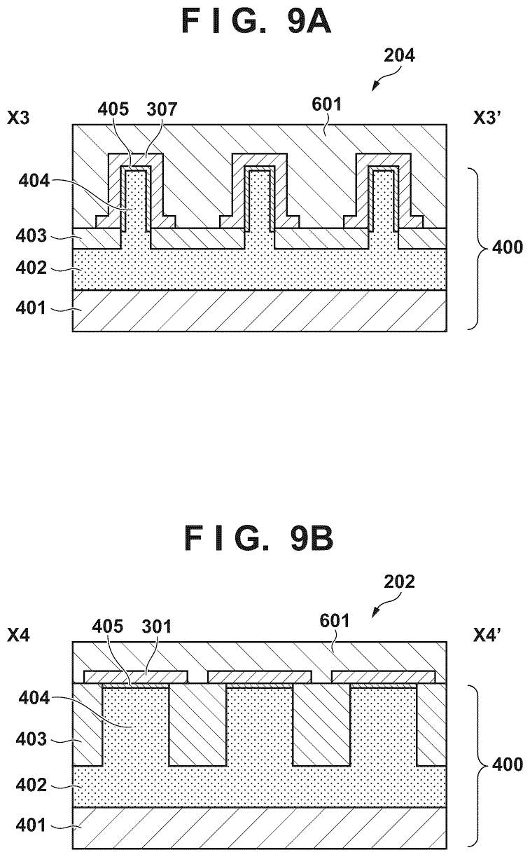

A light-emitting device 101 according to this embodiment will be described with reference to FIGS. 8, 9A and 9B, 10A to 10D, 11A to 11D, and 12A to 12D. The arrangement of the light-emitting device and the circuit arrangement of the pixel 102 shown in FIGS. 1 and 2 apply to the second embodiment. FIG. 8 is a schematic plan view of a plurality of pixels 102 according to this embodiment. FIG. 9A is a cross-sectional view taken along a line X3-X3′ shown in FIG. 8, which is a view for explaining the cross-sectional structure of a switching transistor 204. FIG. 9B is a cross-sectional view taken along a line X4-X4′ shown in FIG. 8, which is a view for explaining the cross-sectional structure of a driving transistor 202.

The difference from the first embodiment is that the switching transistor 204 has a fin gate structure protruding from the base portion of a substrate 400. The gate electrode of the switching transistor 204 is formed in a convex shape relative to the substrate 400, and most of an element isolation portion 403 around a channel region 404 has been removed. The periphery of the channel region 404 is covered with a gate insulating film 405, and a gate electrode 307 is arranged outside the gate insulating film 405 so as to surround the channel region 404. The space between adjacent switching transistors 204 is filled with an interlayer film 601.

In the switching transistor 204 having the structure as described above, most of the channel region 404 except for the lower part can be surrounded by the gate electrode 307, so that it can be expected that the electric field of the gate electrode 307 effectively acts on the channel region 404. This can improve the controllability of the ON/OFF operation (channel formation) due to the gate voltage, and an improvement in image quality can be expected.

The driving transistor 202 has a planar structure as in the first embodiment. When a fin gate structure is applied as the gate electrode of the driving transistor 202, it is necessary to form a space around the channel region 404 for a processing purpose. If shape variation occurs during processing the space, this can result in the characteristic variation of the driving transistor 202. With the planar structure as shown in FIG. 9B, the shape variation caused by formation of the space can be suppressed, so that deterioration of image quality can be minimized. If the characteristic variation of the driving transistor 202 is allowed, the driving transistor 202 having a fin gate structure as shown in FIG. 9A may be used. A write transistor 203 may have a fin gate structure or a planar structure, and can be appropriately selected depending on the convenience of the circuit design, pixel circuit layout, and the like.

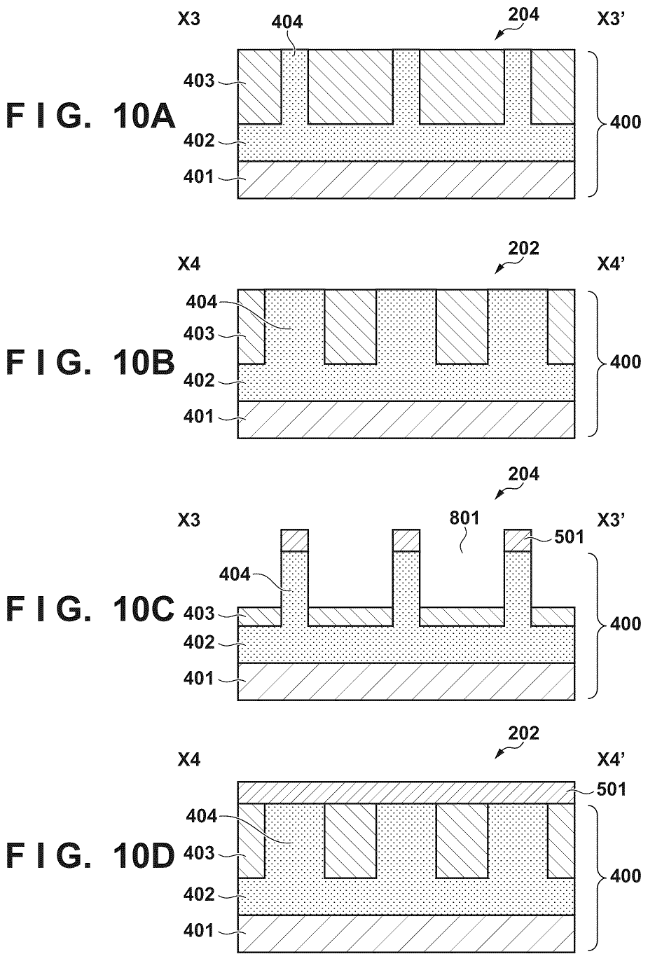

The method of forming transistors constituting the pixel circuit according to this embodiment will be described with reference to FIGS. 10A to 10D, 11A to 11D, and 12A to 12D. FIGS. 10A to 12D are cross-sectional views taken along a line X3-X3′ or a line X4-X4′ shown in FIG. 8, which are views for explaining the cross-sectional structures of the switching transistor 204 and the driving transistor 202. Each of FIGS. 10A, 10C, 11A, 11C, 12A, and 12C is a cross-sectional view of the switching transistor 204 taken along the line X3-X3′. Each of FIGS. 10B, 10D, 11B, 11D, 12B, and 12D is a cross-sectional view of the driving transistor 202 taken along the line X4-X4′.

As shown in FIGS. 10A and 10B, the element isolation portion 403 is formed in the substrate 400 formed from a p-type substrate 401 and an n-type well 402. The element isolation portion 403 can be made of silicon oxide or the like. The element isolation portion 403 can have an STI structure, a LOCOS structure, or the like. A region of the n-type well 402 sandwiched between the element isolation portions 403 is to be the channel region 404. Up to this point, this embodiment is the same as the first embodiment.

As shown in FIGS. 10C and 10D, a resist mask 501 is formed on the substrate 400, and the element isolation portion 403 is partially removed by dry etching or the like to form a space 801. In this example, the driving transistor 202 has a planar structure and the switching transistor 204 has a fin gate structure, so that the space 801 is formed only in the region of the switching transistor 204. The element isolation portion 403 is partially left under the space 801. The space 801 may be formed using wet etching.

After the space 801 is formed, the resist mask 501 is removed. Thereafter, sacrificial oxidation may be performed to remove a layer damaged by etching of the space 801. Isotropic etching may also be performed to round the bottom shape of the space 801 to ensure the embedding characteristic of a polysilicon film. To adjust the threshold value of the transistor, channel doping may be performed by ion implantation or the like.

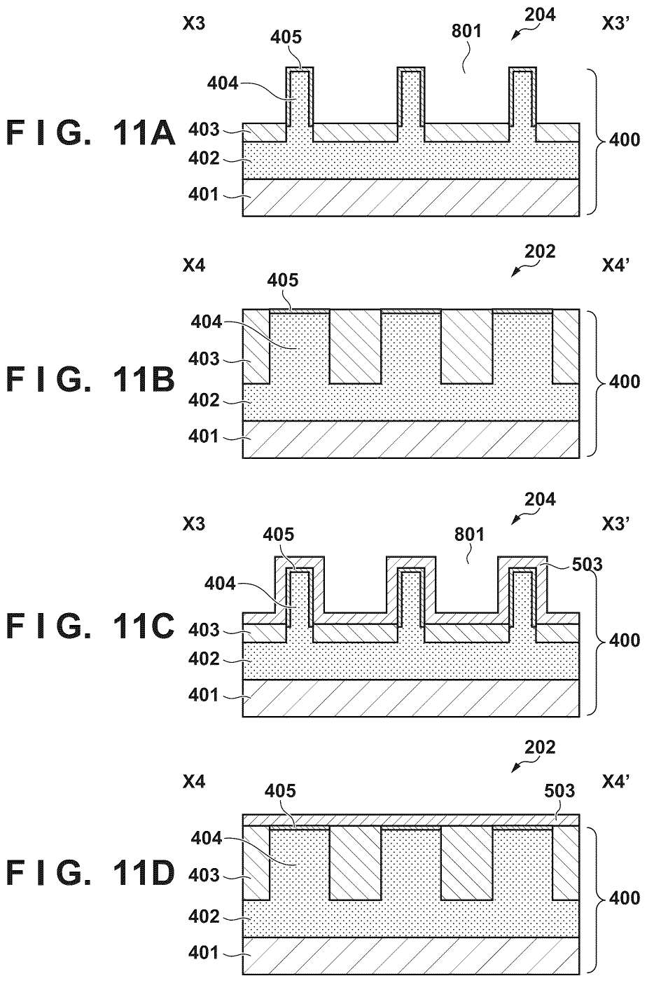

As shown in FIGS. 11A and 11B, the gate insulating film 405 is formed on the substrate 400. The gate insulating film 405 is preferably made of silicon oxide. The silicon oxide film can be formed by thermal oxidation, ISSG oxidation, or the like. Through the steps described above, the gate insulating film 405 is formed on the surface of the substrate 400 including the space 801. The film thickness of the gate insulating film 405 is about 10 to 40 nm, and can be appropriately selected in accordance with the voltage to be applied to the transistor.

Then, as shown in FIGS. 11C and 11D, a polysilicon film 503 is formed on the surface of the substrate 400. The film thickness of the polysilicon film 503 is about 100 to 400 nm. The film thickness of the polysilicon film 503 is desirably equal to or less than ¼ the interval between the channel regions 404 of the switching transistors 204. With this structure, the space 801 is not filled with the polysilicon film 503, and gate electrodes 301 and 307 to be described below can be easily formed.

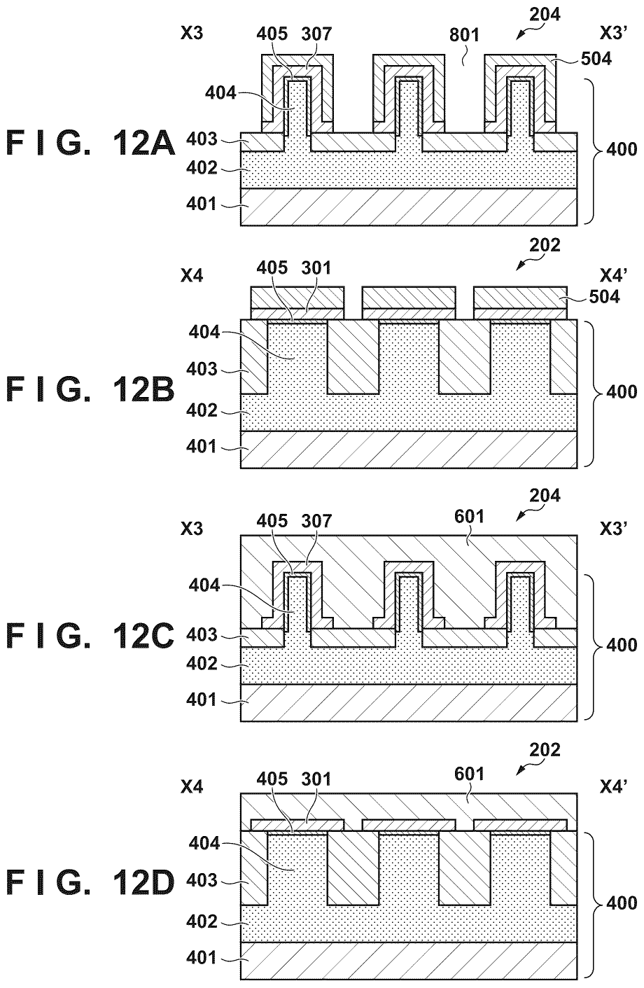

Then, as shown in FIGS. 12A and 12B, a resist mask 504 is formed on the polysilicon film 503, and the gate electrodes 301 and 307 are formed by dry etching or the like.

As shown in FIGS. 12C and 12D, after the resist mask 504 is removed, the interlayer film 601 is formed. Before forming the interlayer film 601, it is possible to form the source region and the drain region by ion implantation or the like, and to form a silicide containing W, Co, or the like in the region to be connected to the contact plug 309, as appropriate.

The above-described method can simultaneously form, on the same substrate, a transistor including a gate electrode having a fin gate structure and a transistor including a gate electrode having a planar structure.

### Application Examples of Light-Emitting Device

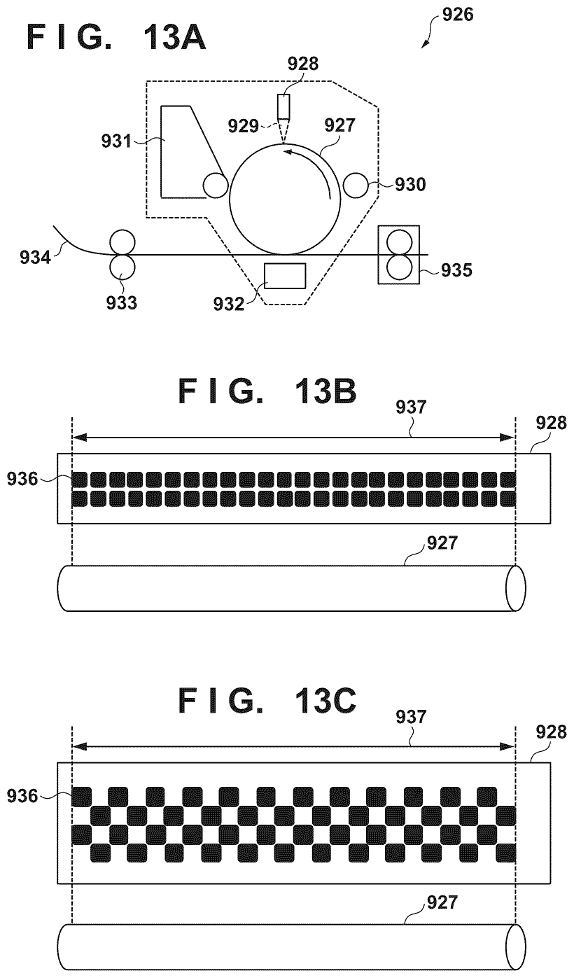

Examples in which the light-emitting device according to each of the above-described first and second embodiments is applied to an apparatus will be described below. An organic light-emitting element is preferably used as the light-emitting element. FIGS. 13A to 13C show an image forming device according to this embodiment. FIG. 13A is a schematic view of an image forming device 926 according to this embodiment. The image forming device includes a photosensitive member 927, an exposure light source 928, a developing device 931, a charging unit 930, a transfer device 932, a conveyance unit 933, and a fixing device 935.

Light 929 is emitted from the exposure light source 928, and an electrostatic latent image is formed on the surface of the photosensitive member 927. The exposure light source includes the light-emitting device according to each of the first and second embodiments. The developing device 931 includes a developing agent such as a toner, and applies the developing agent to the exposed photosensitive member 927. The charging unit 930 charges the photosensitive member 927. The transfer device 932 transfers the developed image to a print medium 934. The conveyance unit 933 conveys the print medium 934. The print medium 934 is, for example, paper. A fixing device 935 fixes the image formed on the print medium.

Each of FIGS. 13B and 13C is a schematic view showing a form in which a plurality of light emitting portions 936 are arranged in the exposure light source 928 on a long substrate. Arrow 937 indicates a direction parallel to the axis of the photosensitive member, which represents a column direction in which light-emitting elements are arrayed. An organic light-emitting element can be used as the light-emitting element. This column direction matches the direction of the axis upon rotating the photosensitive member 927. This direction can also be referred to as the long-axis direction of the photosensitive member.

FIG. 13B shows a form in which the light emitting portions are arranged along the long-axis direction of the photosensitive member. FIG. 13C shows a form which is different from that shown in FIG. 13B and in which the light emitting portions are arranged in the column direction alternately between the first column and the second column. The light emitting portions are arranged at different positions in the row direction between the first column and the second column.

As for the light emitting portions shown in FIG. 13C, the plurality of light emitting portions are arranged apart from each other in the first column. In the second column, the light emitting portion is arranged at the position corresponding to the space between the light emitting portions in the first column. That is, in the row direction as well, the plurality of light emitting portions are arranged apart from each other. The arrangement shown in FIG. 13C can be referred to as, for example, an arrangement in a grid pattern, an arrangement in a staggered pattern, or an arrangement in a checkered pattern.

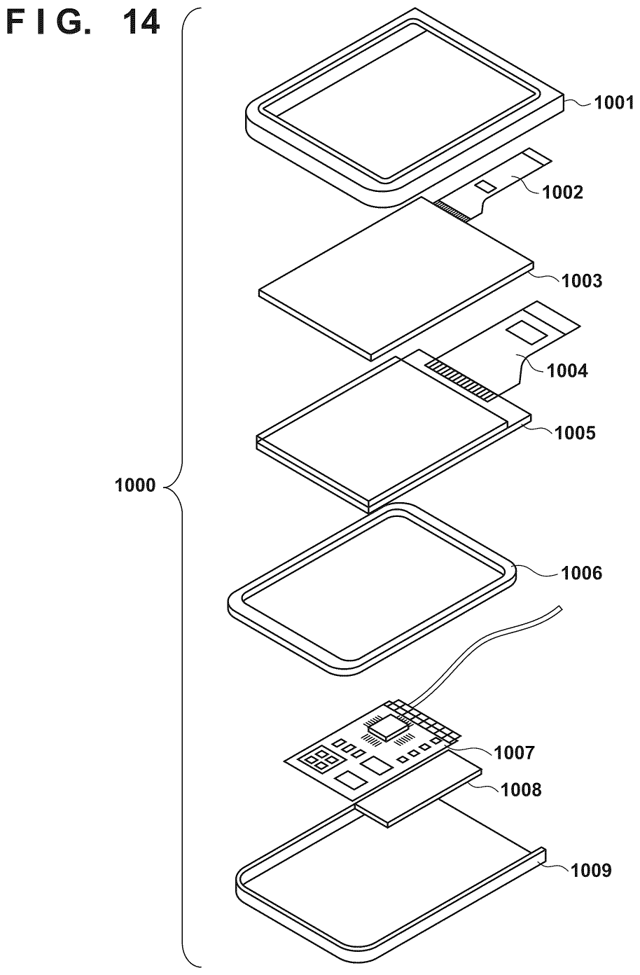

FIG. 14 is a schematic view showing an example of a display device that can use the light-emitting device according to each of the above-described first and second embodiments. A display device 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Transistors are arranged on the circuit board 1007. The battery 1008 is unnecessary if the display device is not a portable apparatus. Even when the display device is a portable apparatus, the battery 1008 may be provided at another position.

The display device according to this embodiment can include color filters of red, green, and blue. The color filters of red, green, and blue can be arranged in a delta array.

The display device according to this embodiment can also be used for a display unit of a portable terminal. At this time, the display unit can have both a display function and an operation function. Examples of the portable terminal are a portable phone such as a smartphone, a tablet, and a head mounted display.

The display device according to this embodiment can be used for a display unit of an image capturing device including an optical unit having a plurality of lenses, and an image capturing element for receiving light having passed through the optical unit. The image capturing device can include a display unit for displaying information acquired by the image capturing element. In addition, the display unit can be either a display unit exposed outside the image capturing device, or a display unit arranged in the finder. The image capturing device can be a digital camera or a digital video camera.

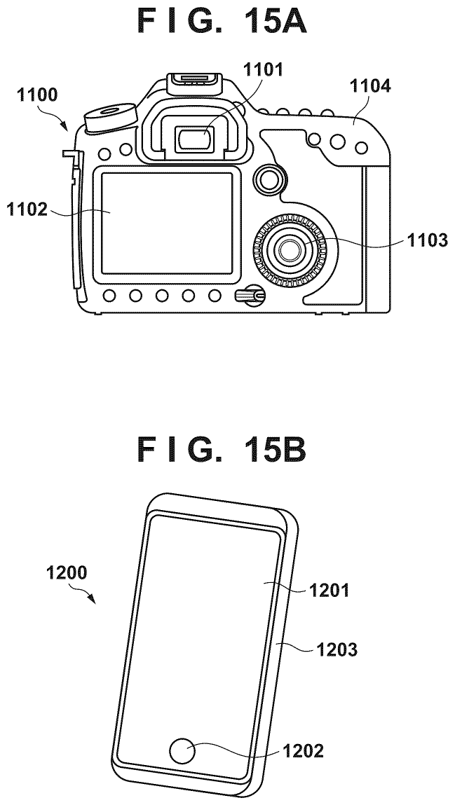

FIG. 15A is a schematic view showing an example of an image capturing device according to this embodiment. An image capturing device 1100 can include a viewfinder 1101, a rear display 1102, an operation unit 1103, and a housing 1104. The viewfinder 1101 may include the display device using the light-emitting device according to each of the first and second embodiments. In this case, the display device can display not only an image to be captured but also environment information, image capturing instructions, and the like. Examples of the environment information are the intensity and direction of external light, the moving velocity of an object, and the possibility that an object is covered with an obstacle.

The timing suitable for image capturing is a very short time, so the information is preferably displayed as soon as possible. Therefore, an organic light-emitting element is preferably used for the light-emitting element. This is so because the organic light-emitting element has a high response speed. The display device using the organic light-emitting element can be used for the devices that require a high display speed more preferably than for the liquid crystal display device.

The image capturing device 1100 includes an optical unit (not shown). This optical unit has a plurality of lenses, and forms an image on an image capturing element that is accommodated in the housing 1104. The focal points of the plurality of lenses can be adjusted by adjusting the relative positions. This operation can also automatically be performed. The image capturing device may be called a photoelectric conversion device. Instead of sequentially capturing an image, the photoelectric conversion device can include, as an image capturing method, a method of detecting the difference from a previous image, a method of extracting an image from an always recorded image, or the like.

FIG. 15B is a schematic view showing an example of an electronic apparatus according to this embodiment. An electronic apparatus 1200 includes a display unit 1201, an operation unit 1202, and a housing 1203. The housing 1203 can accommodate a circuit, a printed board having this circuit, a battery, and a communication unit. The operation unit 1202 can be a button or a touch-panel-type reaction unit. The operation unit can also be a biometric authentication unit that performs unlocking or the like by authenticating the fingerprint. The electronic apparatus including the communication unit can also be regarded as a communication apparatus. The electronic apparatus can further have a camera function by including a lens and an image capturing element. An image captured by the camera function is displayed on the display unit. Examples of the electronic apparatus are a smartphone and a notebook computer.

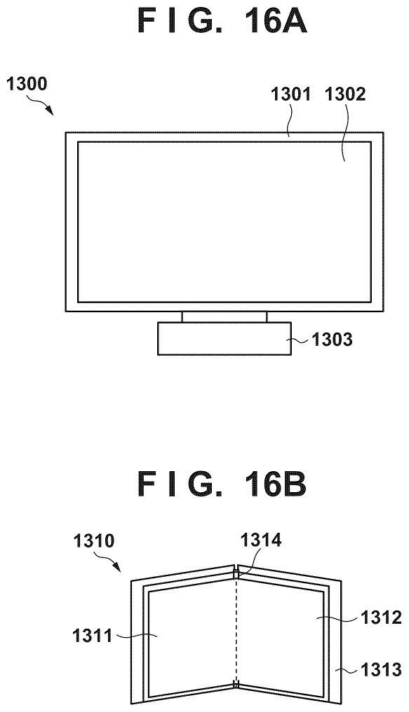

FIGS. 16A and 16B are schematic views showing examples of a display device using the light-emitting device according to each of the first and second embodiments. FIG. 16A shows a display device such as a television monitor or a PC monitor. A display device 1300 includes a frame 1301 and a display unit 1302. When the light-emitting device according to each of the above-described first and second embodiments is used for the display unit 1302, deterioration of a displayed image can be suppressed.

The display device 1300 includes a base 1303 that supports the frame 1301 and the display unit 1302. The base 1303 is not limited to the form shown in FIG. 16A. The lower side of the frame 1301 may also function as the base.

In addition, the frame 1301 and the display unit 1302 can be bent. The radius of curvature in this case can be 5,000 (inclusive) mm to 6,000 (inclusive) mm.

FIG. 16B is a schematic view showing another example of the display device. A display device 1310 shown in FIG. 16B can be folded, that is, the display device 1310 is a so-called foldable display device. The display device 1310 includes a first display unit 1311, a second display unit 1312, a housing 1313, and a bending point 1314. The first display unit 1311 and the second display unit 1312 may include the light-emitting device according to each of the first and second embodiments. The first display unit 1311 and the second display unit 1312 can also be one seamless display device. The first display unit 1311 and the second display unit 1312 can be divided by the bending point. The first display unit 1311 and the second display unit 1312 can display different images, and can also display one image together.

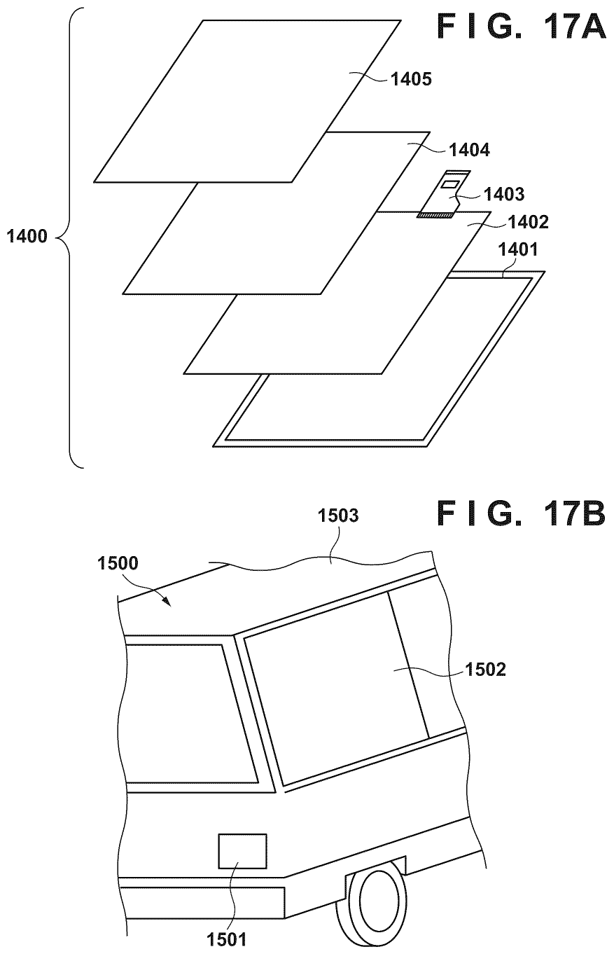

FIG. 17A is a schematic view showing an example of an illumination device using the light-emitting device according to each of the first and second embodiments. An illumination device 1400 may include a housing 1401, a light source 1402, a circuit board 1403, an optical film 1404, and a light diffusing unit 1405. The light source may include the light-emitting device according to each of the first and second embodiments. An organic light emitting element is preferably used for the light-emitting element. The optical film 1404 may be a filter that transmits light and improves the color rendering of the light source. When performing lighting-up or the like, the light diffusing unit can throw the light of the light source over a broad range by effectively diffusing the light. The optical film 1404 and the light diffusing unit 1405 may be provided on the illumination light emission side. The illumination device may also include a cover on the outermost portion, as needed.

The illumination device is, for example, a device for illuminating the interior of the room. The illumination device may emit white light, natural white light, or light of another color from blue to red. The illumination device may include a light control circuit for controlling these light components. The illumination device may include the light-emitting device according to each of the first and second embodiments and a power supply circuit connected thereto. An organic light-emitting element can be used as the light-emitting element of the light-emitting device. The power supply circuit is a circuit for converting an AC voltage into a DC voltage. White has a color temperature of 4,200 K, and natural white has a color temperature of 5,000 K. The illumination device may also include a color filter.

In addition, the illumination device according to this embodiment may include a heat radiation unit. The heat radiation unit radiates the internal heat of the device to the outside of the device, and examples are a metal having a high specific heat and liquid silicon.

FIG. 17B is a schematic view of an automobile as an example of a moving body according to this embodiment, that uses the light-emitting device according to each of the first and second embodiments. The automobile has a taillight as an example of the lighting appliance. An automobile 1500 has a taillight 1501, and may have a form in which the taillight is turned on when performing a braking operation or the like.

The taillight 1501 can include the light-emitting device according to each of the first and second embodiments. The taillight may include a protection member for protecting the light-emitting device. The material of the protection member is not limited as long as the material is a transparent material with a strength that is high to some extent, and is preferably, for example, polycarbonate or the like. A furandicarboxylic acid derivative, an acrylonitrile derivative, or the like may be mixed in polycarbonate.

The automobile 1500 may include a vehicle body 1503, and a window 1502 attached to the vehicle body 1503. The window may be a transparent display as long as it is not a window for checking the front or rear of the automobile. This transparent display may include the light-emitting device according to each of the first and second embodiments. In this case, the constituent materials of the electrodes and the like of the light-emitting device are formed from transparent members.

The moving body according to this embodiment may be a ship, an airplane, a drone, or the like. The moving body may include a main body and a lighting appliance provided on the main body. The lighting appliance may emit light for making a notification of the position of the main body. The lighting appliance includes the light-emitting device according to each of the first and second embodiments.

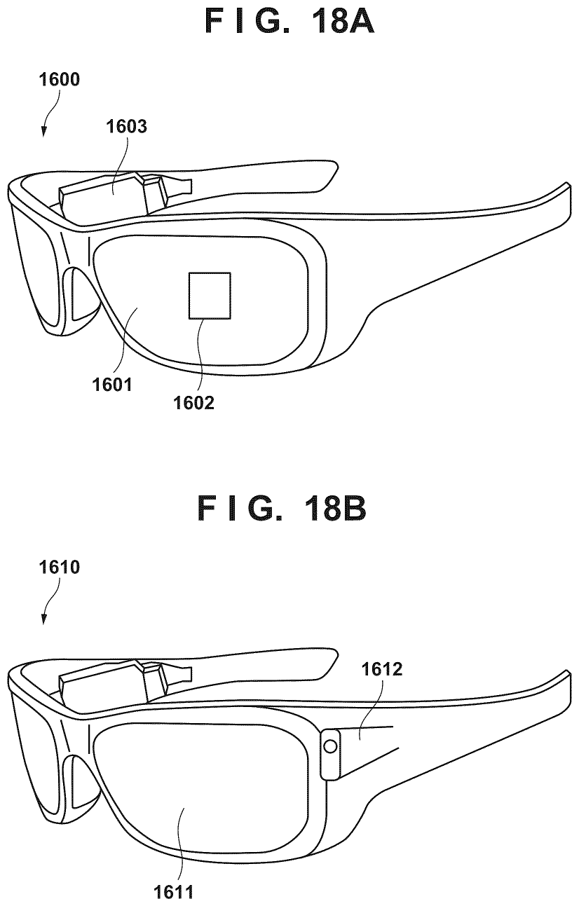

An application example of a display device using the light-emitting device according to each of the first and second embodiments will be described with reference to FIGS. 18A and 18B. The display device can be applied to a system that can be worn as a wearable device such as smartglasses, an HMD, or a smart contact lens. The display device used for such applications can include an image capturing device capable of photoelectrically converting visible light and a display device capable of emitting visible light.

Glasses 1600 (smartglasses) according to one application example will be described with reference to FIG. 18A. An image capturing device 1602 such as a CMOS sensor or an SPAD is provided on the surface side of a lens 1601 of the glasses 1600. In addition, the display device of each of the above-described embodiments is provided on the back surface side of the lens 1601.

The glasses 1600 can further include a control device 1603. The control device 1603 can function as a power supply that supplies power to the image capturing device 1602 and the display device according to each embodiment. In addition, the control device 1603 can control the operations of the image capturing device 1602 and the display device. An optical system configured to condense light to the image capturing device 1602 is formed on the lens 1601.

Glasses 1610 (smartglasses) according to one application example will be described with reference to FIG. 18B. The glasses 1610 includes a control device 1612. An image capturing device corresponding to the image capturing device 1602 and a display device are mounted on the control device 1612. An optical system configured to project light emitted from the display device in the control device 1612 is formed in a lens 1611, and an image is projected to the lens 1611. The control device 1612 functions as a power supply that supplies power to the image capturing device and the display device, and controls the operations of the image capturing device and the display device.

The control device may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light receiving element detects reflected light of the emitted infrared rays from the eyeball, thereby obtaining a captured image of the eyeball. A reduction unit for reducing light from the infrared ray emitting unit to the display unit in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil corneal reflection method is performed. Using pupil corneal reflection method, a line-of-sight vector representing the direction (rotation angle) of the eyeball is calculated based on the image of the pupil and the Purkinje image included in the captured image of the eyeball, thereby detecting the line-of-sight of the user.

The display device according to this embodiment can include an image capturing device including a light receiving element, and a displayed image on the display device can be controlled based on the line-of-sight information of the user from the image capturing device.

More specifically, the display device can decide a first display region at which the user is gazing and a second display region other than the first display region based on the line-of-sight information. The first display region and the second display region may be decided by the control device of the display device, or those decided by an external control device may be received. In the display region of the display device, the display resolution of the first display region may be controlled to be higher than the display resolution of the second display region. That is, the resolution of the second display region may be lower than that of the first display region.

In addition, the display region includes a first display region and a second display region different from the first display region, and a region of higher priority is decided from the first display region and the second display region based on line-of-sight information. The first display region and the second display region may be decided by the control device of the display device, or those decided by an external control device may be received. The resolution of the region of higher priority may be controlled to be higher than the resolution of the region other than the region of higher priority. That is, the resolution of the region of relatively low priority may be low.

Note that AI may be used to decide the first display region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the display device, the image capturing device, or an external device. If the external device holds the AI program, it is transmitted to the display device via communication.

When performing display control based on line-of-sight detection, this can be applied to smartglasses further including an image capturing device configured to capture the outside. The smartglasses can display captured outside information in real time.

As has been described above, by using the light-emitting device according to the embodiment in an apparatus, display with fine image quality and stable even for a long period of time is possible.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-021448 filed Feb. 15, 2024, which is hereby incorporated by reference herein in their entirety.

What is claimed is:

1. A light-emitting device in which a plurality of pixels are arranged in a matrix in a semiconductor substrate, wherein
each of the plurality of pixels includes a light-emitting element, a driving transistor configured to supply a current to the light-emitting element, and a switching transistor configured to control the light-emitting element, and
a gate electrode of the switching transistor is provided on at least two faces of four faces surrounding a cross section of a region to be a channel.

2. The device according to claim 1, wherein a part of the gate electrode is provided in a groove of the semiconductor substrate, and a depth of the groove is larger than twice a thickness of a gate insulating film.

3. The device according to claim 2, wherein the depth of the groove is shallower than a depth of an element insulation portion.

4. The device according to claim 2, wherein a width of the groove is not more than twice a thickness of the gate electrode on a surface of the semiconductor substrate.

5. The device according to claim 1, wherein the gate electrode includes two faces facing with respect to the region to be the channel, and one face between the two faces.

6. The device according to claim 1, wherein the gate electrode of the switching transistor has an inverted U-shape with respect to a bottom surface of the semiconductor substrate in a cross section perpendicular to a direction of a current flowing through the channel.

7. The device according to claim 1, wherein one of a source and a drain of the switching transistor is connected to a connection portion between a first main terminal of the light-emitting element and one of a source and a drain of the driving transistor, and the other of the source and the drain of the switching transistor is connected to a predetermined potential.

8. The device according to claim 7, wherein a region functioning as one of the source and the drain of the switching transistor and a region functioning as one of the source and the drain of the driving transistor share a diffusion region of the semiconductor substrate.

9. The device according to claim 1, wherein a gate electrode of the driving transistor has a planar structure.

10. The device according to claim 1, wherein the driving transistor has an LDD structure.

11. The device according to claim 1, wherein at least one of the driving transistor and the switching transistor includes a silicide in a region where at least one of a source and a drain is arranged.

12. An image forming device comprising a photosensitive member, an exposure light source configured to expose the photosensitive member, a developing device configured to apply a developing agent to the exposed photosensitive member, and a transfer device configured to transfer an image developed by the developing device to a print medium,
wherein the exposure light source includes a light-emitting device defined in claim 1.

13. An image capturing device comprising an optical unit including a plurality of lenses, an image capturing element configured to receive light having passed through the optical unit, and a display unit configured to display an image captured by the image capturing element,
wherein the display unit includes a light-emitting device defined in claim

1.

14. A display device comprising a display unit including a light-emitting device defined in claim 1, and a housing provided with the display unit.

15. An electronic apparatus comprising a display unit including a light-emitting device defined in claim 1, a housing provided with the display unit, and a communication unit provided in the housing and configured to perform external communication.

16. An illumination device comprising a light source including a light-emitting device defined in claim 1, and one of a light diffusing unit and an optical film configured to transmit light emitted by the light source.

17. A mobile body comprising a lighting appliance including a light-emitting device defined in claim 1, and a body provided with the lighting appliance.

18. A wearable device including a display device configured to display an image,
wherein the display device includes a light-emitting device defined in claim 1.
